(19) United States
(12) Patent Application Publication
(10) Pub. No.: US 2026/0200352 A1
(43) Pub. Date: Jul. 16, 2026

(54) CHARGING CONNECTOR FOR ELECTRIC AND HYBRID VEHICLES

(71) Applicant: Kiekert Aktiengesellschaft, Heiligenhaus (DE)

(72) Inventors: Christian STURM, Krefeld (DE); Robert LANDSKRON, Monheim (DE); Christian BAUER, Essen (DE)

(73) Assignee: Kiekert Aktiengesellschaft, Heiligenhaus (DE)

(21) Appl. No.: 19/134,793

(22) PCT Filed: Nov. 9, 2023
(86) PCT No.: PCT/DE2023/100844

§ 371 Date: Jun. 2, 2025

(30) Foreign Application Priority Data
Dec. 9, 2022 (DE) 10 2022 132 872.4

(51) Int. Cl. B60L 53/302; B60L 53/16

(52) U.S. Cl. CPC B60L 53/302; B60L 53/16

(57) ABSTRACT

A charging connector for electric and hybrid vehicles, has a housing and charging contacts, which are arranged in the housing, for contacting corresponding charging contacts of a corresponding charging connector. The invention proposes providing a fluid container which is filled with a fluid and is in thermally conductive contact with at least one of the charging contacts. In this way, heat dissipation is improved for a charging connector that is not itself equipped with a cooling system from a charging station.

The present invention relates to a charging connector for electric and hybrid vehicles, having a housing and charging contacts, which are arranged in the housing, for contacting corresponding charging contacts of a corresponding charging connector, as well as a use of such a charging connector.

Electric and hybrid vehicles have a rechargeable energy storage device, usually a high-voltage battery, which provides energy to an electric drive motor during driving operation. The storage capacities of these high-voltage batteries are limited, such that they must be regularly recharged at a charging station. The battery is charged via a charging cable provided between the charging station and the vehicle, wherein the charging cable is provided on one side with a charging plug that can be plugged into a charging socket provided on the charging station, and on the other side with a charging coupling that can be connected to a built-in charging plug installed in the electric and hybrid vehicle—for example, in accordance with the European standard IEC 62196 Type 2. In the present case, charging sockets, charging plugs, charging couplings, and built-in charging plugs are subsumed under the term “charging connector.” Charging sockets and charging couplings have contact sleeves as charging contacts, and charging plugs as well as built-in charging plugs that can be installed in electric and hybrid vehicles have contact pins as charging contacts that can be plugged into the contact sleeves.

As explained, for example, in EP 3 043 421 A1, a charging current flowing through the charging connector causes it to heat up due to ohmic current heat losses. However, the heating of the charging connector is limited to a threshold temperature increase. For example, according to the IEC 62196-3 standard, the limit temperature increase is limited to 50 K. This in turn leads to a maximum charging current, which generally cannot exceed 200 A in continuous load operation, for largely standardized connector geometries. However, when the battery of an electric or hybrid vehicle is charged intermittently, higher charging currents are necessary over limited periods of time in order to charge the battery in the desired short time. This may lead to temporary heating of the charging connectors above the limit temperature increase. The cable cross-section of the electrical connection bodies cannot be increased arbitrarily, since the plug connector geometries are standardized and, in addition, the smallest possible amount of conductive material, usually copper, should be used for the electrical connection bodies.

In this respect, according to EP 3 043 421 A1, the object to be achieved is to provide an electrical connection body which enables increased charging currents with limited heating and therefore has an increased short-time current carrying capacity. This object is to be achieved by providing an electrical connection body for a charging plug or a charging socket, wherein the electrical connection body has a first connection region for galvanic connection to an electrical energy receiver and a second connection region for galvanic connection to an electrical energy source, wherein the electrical connection body is designed such that it has a cooling fluid channel formed in the electrical connection body, wherein the cooling fluid channel of the electrical connection body is fluidically connected to a cooling fluid source which is arranged in a charging station.

Cooling of a charging connector for electric and hybrid vehicles, which originates from the side of the charging station, is also well known from the prior art. DE 10 2015 119 338 A1 describes that two connection points for coolant lines are arranged on a contact sleeve element of a charging plug. By means of a spiral-shaped plug-on element, coolant is guided circularly around the contact sleeve element. The two connection points serve as inlet and outlet for the coolant, which is fed from the charging station to the charging plug. EP 3 433 902 B1 also describes a plug connector part with cooled contact elements. Here, too, the charging station provides for the supply of a coolant via coolant lines to the contact elements of the charging coupling connected to the charging cable. A fluid is provided as a coolant, which is directed perpendicularly to the contact element into the hollowed-out contact element and flows back within the contact element.

Finally, 10 2016 105 361 B4 also describes a plug connector part with a cooled contact element, wherein here, too, on the charging station side, the supply of a coolant via coolant lines to the contact elements of a charging socket connected to the charging cable is provided. Guide elements are arranged on the contact elements to ensure that the coolant in the form of compressed air flows around the contact elements.

Based upon this, the object of the present invention is to achieve improved heat dissipation in a charging connector that is not itself equipped with a cooling system from a charging station.

The object of the invention is achieved by the subject matter of the independent claims. Preferred developments of the invention are described in the dependent claims.

According to the invention, a charging connector for electric and hybrid vehicles is thus provided, having a housing, charging contacts arranged in the housing for contacting corresponding charging contacts of a corresponding charging connector, and a fluid container filled with a fluid and in thermally conductive contact with at least one of the charging contacts.

A key aspect of the invention is that the energy generated at a charging contact during charging is absorbed by the fluid, so that overheating of the charging contact and the charging connector can be avoided.

In principle, various fluids can be used for the invention. Preferably, however, the fluid is a liquid, e.g., water or a mixture of water and another substance-very particularly preferably a glycol-water mixture. Glycols are often used in coolants, antifreeze, and de-icers because their melting point of −10 to −15° C. is lower than that of water. In combination with water, i.e., in the glycol-water mixture mentioned here, the melting point is even lower and can reach −55° C. depending upon the mixing ratio. In this way, the fluid remains liquid even at very low temperatures, which allows the invention to be widely used even in very cold climates. Alternatively, according to a preferred development, the fluid is an oil, preferably a mineral oil, a vegetable oil, a silicone oil, or a synthetic oil.

The fluid container can be thermally coupled to the charging contact in different ways. However, according to a preferred development of the invention, the fluid container is connected to at least one of the charging contacts by means of a heat pipe. A heat pipe is a heat exchanger that allows a high heat flux density by utilizing the evaporation enthalpy of a medium. In this way, large amounts of heat can be transferred onto a small cross-sectional area.

The heat pipe can be connected to the charging contact in different ways. However, according to a preferred development of the invention, the heat pipe is inserted into the charging contact transversely to the longitudinal direction of the latter. Furthermore, according to a preferred development of the invention, the charging contact is pin-shaped, and the heat pipe runs within the charging contact in the longitudinal direction of the latter. This allows a long contact path between the charging contact and the heat pipe, which further improves the heat transfer between the charging contact and the heat pipe.

According to an alternative embodiment of the invention without a heat pipe, it is provided that the fluid container have a wall with two openings through which at least one of the charging contacts is passed. In this way, the charging contact inside the fluid container comes into contact with the fluid, which also enables effective heat transfer from the charging contact to the fluid.

It is in general possible that the charging contact come into direct contact with the fluid. However, according to a preferred development of the invention, it is provided that the charging contact, at least in its region within the fluid container, have a galvanically insulating coating, e.g., made of an electrically insulating but highly thermally conductive plastic. In this way, the charging contact is electrically insulated from the fluid, which is advantageous from a safety perspective, without significantly affecting the heat transfer from the charging contact to the fluid.

In order to reliably prevent leaks at the fluid container, according to a preferred development of the invention, the fluid container is arranged within the housing of the charging connector, wherein the cavity between the inner wall of the housing and the fluid container is at least partially, preferably completely, potted with a potting compound. In this way, sealing of the fluid container is not achieved only by seals at the openings of the fluid container. Rather, it is possible to seal the fluid container as a whole, i.e., along its entire surface, if it is completely embedded in the potting compound. Casting resin has proven to be particularly suitable as a potting compound. A casting resin is a synthetic resin that is processed in liquid form into the final product and then solidifies as this or as a component of it. The still liquid resin is poured into the housing in which the other components of the charging connector, such as the charging contacts and the fluid container, are already arranged. This ultimately creates a casting resin body with free-form surfaces that securely and sealingly encloses the other components of the charging connector in its housing.

Finally, according to a preferred embodiment of the invention, the volume of the fluid is between 150 and 20 mL, preferably between 60 and 20 mL, most preferably between 40 and 20 mL. In the context of the invention, it has been found that even such small amounts of a fluid can be sufficient to effectively dissipate from the charging contact the heat generated during a high-performance charging process for an electric vehicle, e.g., if a mixture of water and glycol is used as the fluid.

In addition, the aforementioned object is also achieved by using a previously described charging connector on the vehicle body of an electric or hybrid vehicle. The charging connector is very particularly preferably a charging plug in accordance with the IEC 62196 standard.

The invention is explained in greater detail below with reference to drawings which show only exemplary embodiments.

In the drawings,

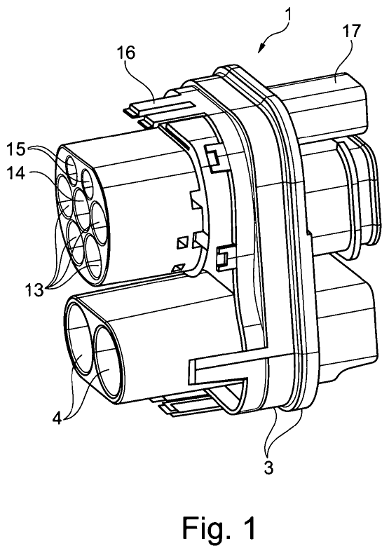

FIG. 1 is a perspectival view of a charging connector according to a preferred exemplary embodiment of the invention,

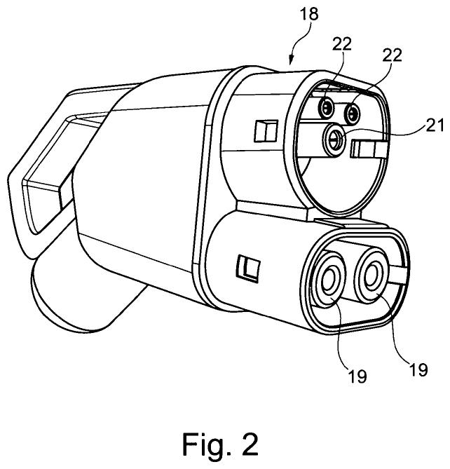

FIG. 2 is a perspectival view of a charging connector corresponding to the charging connector of FIG. 1,

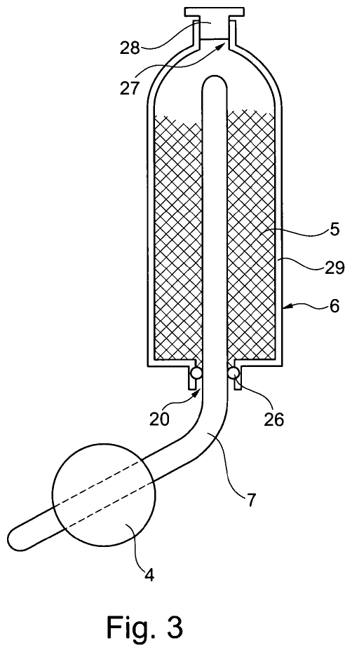

FIG. 3 schematically shows a first exemplary embodiment of the invention for cooling a charging contact of a charging connector by means of a fluid provided in a fluid container,

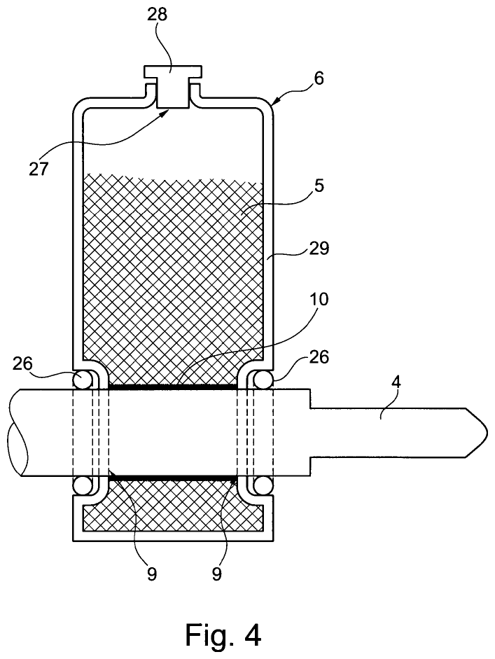

FIG. 4 schematically shows a first exemplary embodiment of the invention for cooling a charging contact of a charging connector by means of a fluid provided in a fluid container,

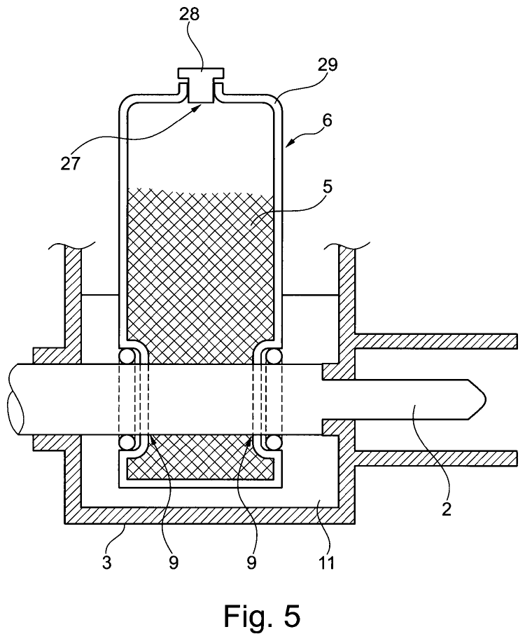

FIG. 5 schematically shows a first exemplary embodiment of the invention for cooling a charging contact of a charging connector by means of a fluid provided in a fluid container,

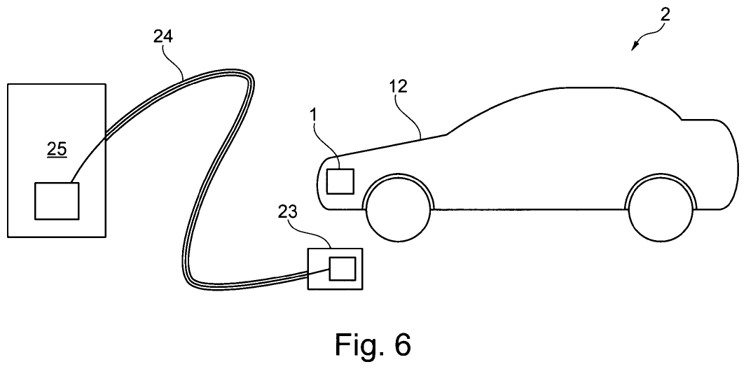

FIG. 6 schematically shows an electric or hybrid vehicle with a charging connector according to a preferred exemplary embodiment of the invention.

FIG. 1 shows a perspectival view of a charging connector 1 according to a preferred exemplary embodiment of the invention. This is a charging plug for installation in the vehicle body 12 of an electric or hybrid vehicle 2, as shown schematically in FIG. 6. The present charging connector 1 is substantially and in terms of its mating face a charging plug in accordance with the European standard IEC 62196 Type 2. In addition to AC charging contacts 13 for AC charging, a protective contact 14, and communications contacts 15, the charging connector 1 has two DC charging contacts 4 for DC charging.

The charging connector 1 is in the present case composed of a first housing part 16 and a second housing part 17, which together form the housing 3 of the charging connector 1. The first housing part 16 is connected to the second housing part 17 by laser welding. The first housing part 16 corresponds to the housing part which, when installed in the vehicle body 12 of an electric or hybrid vehicle 2, faces outwards and, as indicated in FIG. 6, is intended to receive a corresponding charging connector 18 which is designed as a charging coupling.

Such a corresponding charging connector 18 can be seen in a perspectival view in FIG. 2. This is a charging coupling for DC charging, the connector face of which complies with the European standard IEC 62196 Type 2. For DC charging, two corresponding charging contacts 19 are provided, which interact with the DC charging contacts 4 of the charging connector 1 during charging. In addition, the corresponding charging connector 19 has two communications contacts 22 and a protective contact 21. Specifically, in the present case, the DC charging contacts 22 of the charging connector 1 are designed as contact pins, and the corresponding DC charging contacts 19 of the corresponding charging connector 18 are designed as contact sleeves into which the contact pins can be inserted.

It is then essential that the charging connector 1 be equipped with a fluid container 6 which is filled with a fluid 5 and is in thermally conductive contact with the two DC charging contacts 4. Various designs are possible, as shown schematically in FIGS. 3, 4, and 5.

FIG. 3 schematically shows a first exemplary embodiment of the invention for cooling the DC charging contacts 4 of a charging connector 1 by means of a fluid 5 provided in a fluid container 6. The fluid 5 is in this case a glycol-water mixture with a volume of 40 mL, which has been filled into the fluid container 6 via an opening 27 which is now closed with a closure 28.

As can be seen from FIG. 3, the fluid container 6 is not directly coupled to the DC charging contact 4 shown there. Rather, between the DC charging contact 4 and the fluid container 6, a heat pipe 7 is arranged which ensures effective heat transfer from the DC charging contact 4 to the fluid 5 provided in the fluid container 6.

The heat pipe is guided into the interior of the fluid container 6 via an opening 20 sealed by a seal 26, in such a way that the heat pipe 7 projects within the fluid container 6 beyond the fill level of the fluid 5 in the fluid container 6. In this way, a long contact path between the heat pipe 7 and the fluid 5 is ensured, which enables effective heat transfer from the heat pipe 7 to the fluid 5.

The contact of the heat pipe 7 with the DC charging contact 4 is shown here only very schematically. Specifically, the heat pipe 7 can be inserted into the charging contact 4 transversely to the longitudinal direction of the latter. Alternatively or additionally, it is also possible for the heat pipe 7 to run within the charging contact 4 in the longitudinal direction of the latter. The latter allows a relatively long path of the heat pipe 7 within the charging contact 4, which further improves the thermal coupling of the heat pipe 7 to the charging contact 4.

FIG. 4 now schematically shows a second exemplary embodiment of the invention for cooling the DC charging contacts 4 of a charging connector 1 by means of a fluid 5 provided in a fluid container 6. The key difference from the first, preferred exemplary embodiment of the invention is that the coupling of the fluid 5 to the DC charging contact 4 is not carried out with a heat pipe 7. Rather, the fluid container 6 is provided with a wall 8 which has two openings 9 through which a respective DC charging contact 4 is passed. The openings 9 are each sealed by a seal 26.

For safety reasons, the DC charging contact 4 has a galvanically insulating coating 10 in its region within the fluid container 6 in order to achieve electrical insulation from the fluid 5. For this galvanically insulating coating, an electrically insulating plastic has been chosen which, however, has good thermal conductivity, so that the thermal coupling of the heat pipe 7 to the fluid 5 is, in effect, not impaired.

FIG. 5 shows, as a third preferred exemplary embodiment of the invention, such a development of the second exemplary embodiment of the invention, in which the fluid container 6 is formed within the housing 3 of the charging connector, and the cavity between the inner wall of the housing 3 and the fluid container 6 is potted with a potting compound 11 in such a way that possible leaks in the region of the openings 9 of the fluid container 6 are avoided. In this case, a casting resin is used as the potting compound, i.e., a synthetic resin that is processed in liquid form into the final product and solidifies as this or its component. The still liquid resin has for this purpose been poured into the housing in which the other components of the charging connector 1, such as the charging contacts 4 and the fluid container 6, have already been arranged. This results in a casting resin body with free-form surfaces that securely and sealingly encloses the other components of the charging connector 1 in its housing 3.

It has already been mentioned above that the charging connector 1 is used in the present case in the form of a built-in plug on the vehicle body 12 of an electric or hybrid vehicle 2. In this context, reference may be made to FIG. 6, which schematically shows a system according to a preferred exemplary embodiment of the invention, which comprises a charging connector 1 installed in a vehicle body 12 of an electric or hybrid vehicle 2, a charging connector 18 corresponding thereto in the form of a charging coupling, a charging station 25, and a charging cable 24 connected to the charging station 20 and carrying the charging coupling 23.

### LIST OF REFERENCE SIGNS

1 charging connector
2 electric and hybrid vehicles
3 housing
4 charging contacts/DC charging contacts
5 fluid
6 fluid container
7 heat pipe
8 wall
9 opening
10 coating
11 potting compound
12 vehicle body
13 AC charging contacts
14 protective contact
15 communications contacts
16 first housing part
17 second housing part
18 corresponding charging connector
19 corresponding charging contact
20 opening
21 corresponding protective contact
22 corresponding communications contacts
23 charging coupling
24 charging cable
25 charging station
26 seal
27 opening
28 closure
29 wall

1. A charging connector for electric and hybrid vehicles, having
a housing,
charging contacts arranged in the housing for contacting corresponding charging contacts of a corresponding charging connector, and
a fluid container filled with a fluid and in thermally conductive contact with at least one of the charging contacts.

2. The charging connector according to claim 1, wherein the fluid is a liquid.

3. The charging connector according to claim 2, wherein the liquid is water or a mixture of water and another substance or an oil.

4. The charging connector according to claim 1, wherein the fluid container is connected to at least one of the charging contacts by means of a heat pipe.

5. The charging connector according to claim 4, wherein the heat pipe is inserted into the charging contact transversely to the longitudinal direction of the latter.

6. The charging connector according to claim 4, wherein the charging contact is pin-shaped, and the heat pipe runs within the charging contact in the longitudinal direction of the latter.

7. The charging connector according to claim 1, wherein the fluid container has a wall with two openings through which at least one of the charging contacts is passed.

8. The charging connector according to claim 7, wherein the charging contact, at least in its region within the fluid container, has a galvanically insulating coating.

9. The charging connector according to claim 1, wherein the fluid container is formed within the housing, and the cavity between the inner wall of the housing and the fluid container is at least partially potted with a potting compound.

10. The charging connector according to claim 1, wherein the volume of the fluid is between 150 and 20 mL.

11. The use of a charging connector according to claim 1, on the vehicle body of an electric or hybrid vehicle.
